(19) United States
(12) Patent Application Publication
(10) Pub. No.: US 2007/0222761 A1
(43) Pub. Date: Sep. 27, 2007

(54) APPARATUS FOR DEFINING KEYSTROKE VALUES OF KEYBOARD, KEYBOARD WITH DEFINABLE KEYSTROKE VALUES, AND METHOD THEREFOR

(75) Inventors: Shih-Fang Wong, Shenzhen (CN); Jun Li, Shenzhen (CN); Jun-Wei Zhang, Shenzhen (CN); Wen-Jian Cui, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/617,730

(22) Filed: Dec. 29, 2006

(30) Foreign Application Priority Data
Mar. 21, 2006 (CN) 200610034600.5

(51) Int. Cl. G09G 5/00

(52) U.S. Cl. 345/172

(57) ABSTRACT

A keyboard with definable keystroke values is provided. The keyboard includes an output interface for connecting to a keyboard interface of a host computer; keycaps for receiving operational inputs; a signal generation unit for generating keystroke signals in response to the operational inputs on the keycaps; a storage unit; and a micro control unit (MCU). The MCU includes a defining module for defining keystroke mappings between keystrokes and keystroke values in a user-defined keystroke mode, and storing the keystroke mapping into the storage unit; and an output control module for receiving the keystroke signals from the signal generation unit, reading the corresponding mapped keystroke values from the keystroke mapping stored in the storage unit in the user-defined keystroke mode, and outputting the mapped keystroke values to the keyboard interface of the host computer through the output interface.

### BACKGROUND

1. Technical Field

The present invention relates to apparatus for defining keystroke values of keyboard, keyboard with definable keystroke values, and method therefor.

2. General Background

Even though that speeds of CPUs has increased, and data capacity of hard disks has grown, the layout of the keys of the keyboard, is still the same. It is commonly believed that the “QWERTY” keyboard, invented in 1870's by Christopher Latham Sholes, was intended to slow a typist down, because the typewriter was so inefficiency that the keys jammed when the operator typed at a normal speed. So what Sholes attempted to do was to separate the letters of as many common digraphs as possible. Unfortunately, even after the jamming problem has ceased in the emergence of the keyboard, most of users do not attend to change. Consequently, the “QWERTY” layout is not a suited layout of the keys of the keyboard.

What is needed, therefore, is an apparatus, a keyboard and method for defining layout, i.e., keystroke values of a keyboard.

### SUMMARY

An apparatus for defining keystroke values of a keyboard is provided. The apparatus includes a first interface for connecting to a keyboard interface of a host computer; a second interface for connecting to a keyboard, and receiving keystroke signals from the keyboard; a storage unit; and a micro control unit (MCU). The MCU includes a defining module for defining keystroke mappings between keystrokes and keystroke values in a user-defined keystroke mode, and storing the keystroke mapping into the storage unit; and an output control module for receiving the keystroke signals from the second interface, reading the corresponding mapped keystroke values from the keystroke mapping stored in the storage unit in the user-defined keystroke mode, and outputting the mapped keystroke values to the keyboard interface of the host computer through the first interface.

A keyboard with definable keystroke values is provided. The keyboard includes an output interface for connecting to a keyboard interface of a host computer; keycaps for receiving operational inputs; a signal generation unit for generating keystroke signals in response to the operational inputs on the keycaps; a storage unit; and a micro control unit (MCU). The MCU includes a defining module for defining keystroke mappings between keystrokes and keystroke values in a user-defined keystroke mode, and storing the keystroke mapping into the storage unit; and an output control module for receiving the keystroke signals from the signal generation unit, reading the corresponding mapped keystroke values from the keystroke mapping stored in the storage unit in the user-defined keystroke mode, and outputting the mapped keystroke values to the keyboard interface of the host computer through the output interface.

A method for defining keystroke values of a keyboard is provided. The method includes the steps of: defining keystroke mappings between keystrokes and keystroke values in a user-defined keystroke mode of the keyboard, and storing the keystroke mapping; generating keystroke signals in response to the operational inputs on keycaps of the keyboard; receiving keystroke signals; reading corresponding mapped keystroke values from the keystroke mapping in response to the keystroke signals, in the user-defined keystroke mode; and outputting the mapped keystroke values to a host computer.

Other advantages and novel features will be drawn from the following detailed description with reference to the attached drawing, in which:

### BRIEF DESCRIPTION OF THE DRAWINGS

FIG. 1 is a schematic diagram of a hardware infrastructure of an apparatus for defining keystroke values of a keyboard in accordance with a preferred embodiment of the present invention;

FIG. 2 is a schematic diagram of a hardware infrastructure of an apparatus for defining keystroke values of a keyboard in accordance with an alternative embodiment of the present invention; and

FIG. 3 is a flowchart of a preferred method for defining keystroke values of a keyboard in a user-defined keystroke mode by utilizing the apparatus of FIG. 1 or FIG. 2.

### DETAILED DESCRIPTION OF THE EMBODIMENT

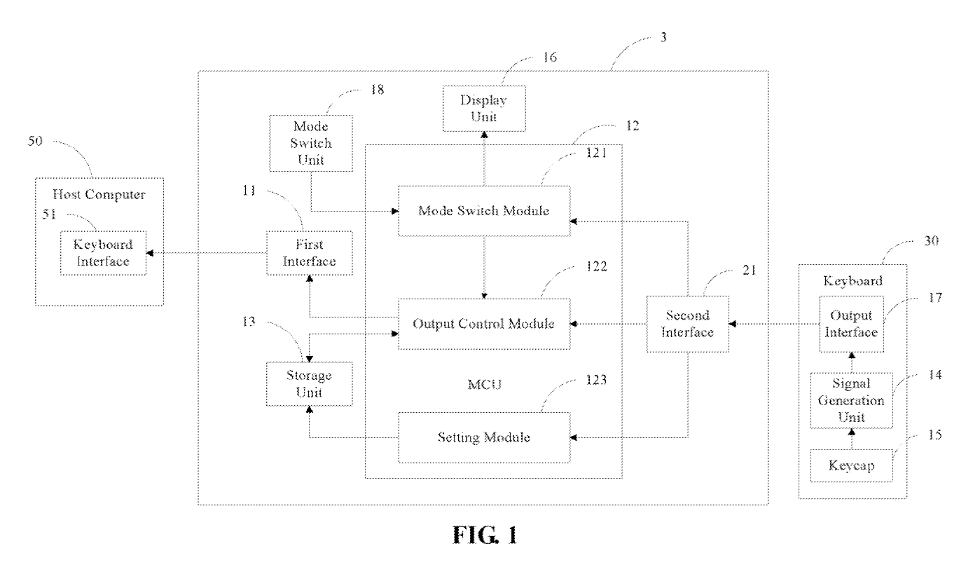

FIG. 1 is a schematic diagram of a hardware infrastructure of an apparatus for defining keystroke values of a keyboard in accordance with a preferred embodiment of the present invention. The apparatus 1 includes a first interface 11, a second interface 21, a microcontroller unit (MCU) 12, a storage unit 13, a display unit 16, and a mode switch unit 18. The first interface 11 is for connecting the apparatus 1 to a keyboard interface 51 of a host computer 50. The second interface 21 is for connecting the apparatus 1 to an output interface 17 of a keyboard 30. The keyboard 30 includes a plurality of keycaps 15 and a signal generation unit 14. The keycaps are configured for receiving operational inputs in response to users'strokes. The signal generation unit 14 is configured for generating keystroke signals in response to the operational inputs on the keycaps 15.

The MCU 12 includes a mode switch module 121, an output control module 122, and a defining module 123. The defining module 123 is for defining keystroke mappings between keystrokes and keystroke values in a user-defined keystroke mode, and storing the keystroke mappings into the storage unit 13. The output control module 122 is configured for outputting corresponding keystroke values according to a current keystroke mode of the keyboard 1.

In a normal keystroke mode, the output control module 122 receives the keystroke signals from the signal generation unit 14 through the second interface 21, and outputs default keystroke values indicated by the keycaps 15 to the keyboard interface 51 through the first interface 11. For example, when a keycap “A” is stroked in the normal keystroke mode, the output control module 122 outputs a default keystroke value “A”.

Alternatively, in the user-defined keystroke mode, the output control module 122 receives the keystroke signals from the signal generation unit 14 through the second interface 21, reads corresponding mapped keystroke values from the keystroke mappings stored in the storage unit 13, and outputs the mapped keystroke values to the keyboard interface 51 through the first interface 11. For example, when the keycap “A”is stroked in the user-defined keystroke mode, the output control module 122 outputs the corresponding mapped keystroke value from the keystroke mappings instead of the default keystroke value “A”. The mapped keystroke value can be a single keystroke value or a combination of several keystroke values. For example, in one case, the mapped keystroke value of the keycap “A” may be “T”; in another case, the mapped keystroke value of the keycap “A” may be a keystroke combination, e.g., “Ctrl+C”.

The apparatus 1 may have one or more user-defined keystroke modes. In response to an operation on the mode switch unit 18, the mode switch module 121 switches between the normal keystroke mode and the user-defined keystroke mode correspondingly, and also generates a current mode signal indicative of the current mode of the apparatus 1 to the output control module 122 and the display unit 16. Consequently, the display unit 16 displays the current mode information according to the current mode signal.

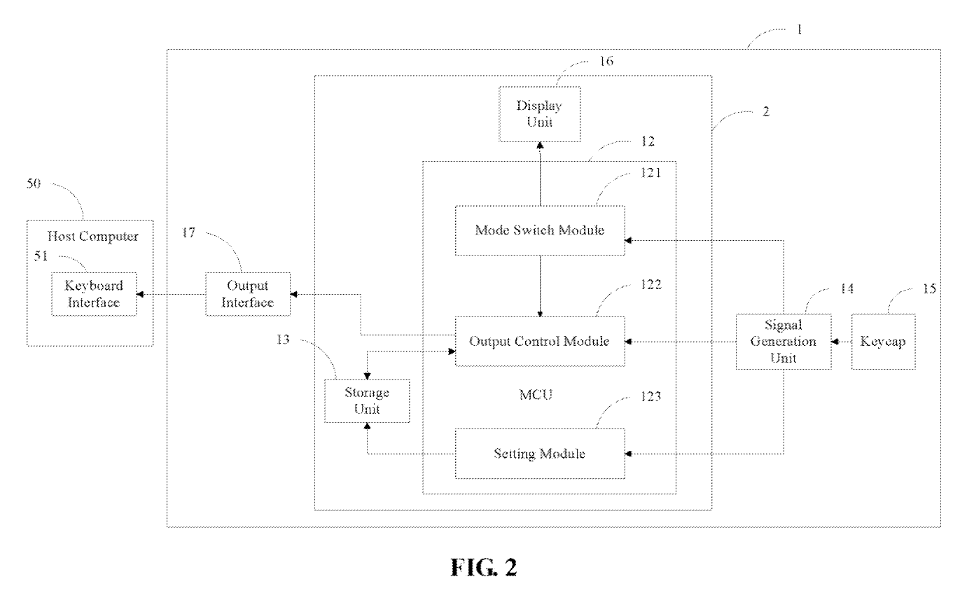

FIG. 2 is a schematic diagram of a hardware infrastructure of an apparatus for defining keystroke values of a keyboard in accordance with an alternative embodiment of the present invention. The apparatus 2 of the alternative embodiment is incorporated into a keyboard 3 as compared to the apparatus 1 of the preferred embodiment that is independent from the keyboard 30. The apparatus 2 includes the same components of the apparatus 1 as that shown in FIG. 1 except the first interface 11, the second interface 21, and the mode switch unit 18. Here, like components to those of FIG. 1 have the same reference numeral used and therefore, an explanation of their configurations and functions is omitted.

The differences between the preferred embodiment and the alternative embodiment are: in the preferred embodiment, the apparatus 1 is connected to the keyboard 30, and each module of the MCU 12 receives the keystroke signals from the signal generation unit 14 through the second interface 21 of the apparatus 1, and the output control module 122 outputs the keystroke values to the host computer 50 through a first interface 11 of the apparatus 1; in the alternative embodiment, the apparatus 2 is incorporated into the keyboard 3, and each module of the MCU 12 receives the keystroke signals directly from the signal generation unit 14 without the second interface 21, and the output control module 122 outputs the keystroke values to the host computer 50 through the output interface 17 of the keyboard 3.

Furthermore, in the alternative embodiment, the keycaps 15 of the keyboard 3 can be defined and used as mode switch keys instead of the mode switch unit 18 in FIG. 1. Therefore, the mode switch module 121 in the alternative embodiment switches to the user-defined keystroke mode or the normal keystroke mode corresponding in response to the stroke operation on the defined keycap 15 instead of on the mode switch unit 18 in FIG.

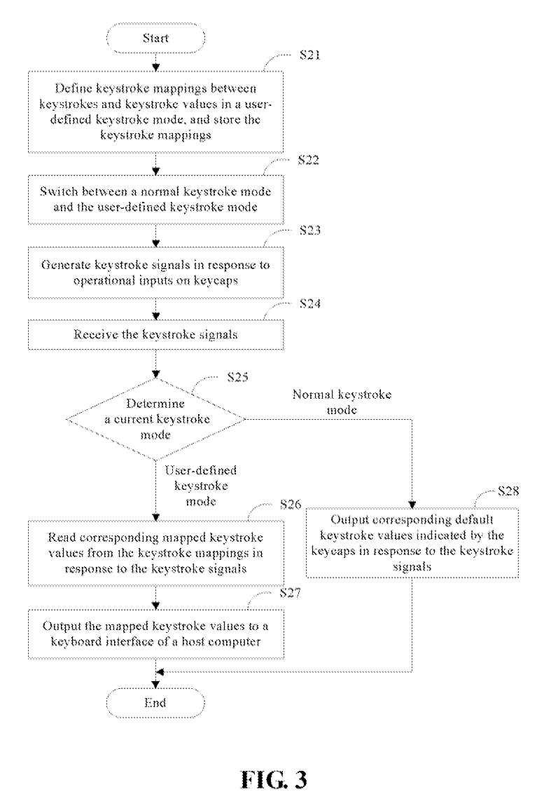

FIG. 3 is a flowchart of a preferred method for defining the keystroke values of the keyboard in the user-defined keystroke mode by utilizing the apparatus 1 of FIG. 1 or the apparatus 2 of FIG. 2.

In step S21, the defining module 123 defines the keystroke mappings between the keystrokes and the keystroke values in the user-defined keystroke mode, and stores the keystroke mappings into the storage unit 13.

In step S22, the mode switch module 121 switches between the normal keystroke mode and the user-defined keystroke mode in response to the stroke operation on the mode switch key, and also generates the current mode signal to the output control module 122 and the display unit 16.

In step S23, the signal generation unit 14 generates keystroke signals in response to the operational inputs on the keycaps 15.

In step S24, the output control module 122 receives the keystroke signals through the second interface 21 in the preferred embodiment, or directly from the signal generation unit 14 in the alternative embodiment.

In step S25, the output control module 122 determines the current keystroke mode of the keyboard 1 according to the current mode signal.

If the current mode signal is indicative of the user-defined keystroke mode, in step S26, the output control module 122 reads corresponding mapped keystroke values from the keystroke mappings in response to the keystroke signals.

In step S27, the output control module 122 outputs the mapped keystroke values to the keyboard interface 51 of the host computer 50 through the first interface 11 in the first preferred embodiments, or through the output interface 17 in the alternative embodiments.

If the current mode signal is indicative of the normal keystroke mode, in step S28, the output control module 122 outputs the default keystroke values indicated by the keycaps 15 in response to the keystroke signals corresponding.

Therefore, by utilizing the apparatus 1 or the apparatus 2, users can define layouts of keys of a keyboard, and also define a single keystroke to perform as combined keystrokes, which simplifies users'stroking operations and brings convenience.

Although the present invention has been specifically described on the basis of preferred embodiments and preferred methods thereof, the invention is not to be construed as being limited thereto. Various changes or modifications may be made to the embodiment and method without departing from the scope and spirit of the invention.

What is claimed is:

1. A keyboard with definable keystroke values, comprising:
an output interface for connecting to a keyboard interface of a host computer;
keycaps for receiving operational inputs;
a signal generation unit for generating keystroke signals in response to the operational inputs on the keycaps;
a storage unit; and
a micro control unit (MCU), comprising:
a defining module for defining keystroke mappings between keystrokes and keystroke values in a user-defined keystroke mode, and storing the keystroke mapping into the storage unit; and
an output control module for receiving the keystroke signals from the signal generation unit, reading the corresponding mapped keystroke values from the keystroke mapping stored in the storage unit in the user-defined keystroke mode, and outputting the mapped keystroke values to the keyboard interface of the host computer through the output interface.

2. The keyboard according to claim 1, wherein the MCU further comprises a mode switch module for switching between a normal keystroke mode and the user-defined keystroke mode, in the normal keystroke mode, the output control module receives the keystroke signals from the signal generation unit, and outputs default keystroke values indicated by the keycaps to the keyboard interface of the host computer through the output interface.

3. The keyboard according to claim 1, wherein the mapped keystroke value is selected from a group consisting of a keystroke value and a keystroke combination value.

4. The keyboard according to claim 1, wherein the mode switch module further generates a current mode signal indicating the current mode of the keyboard.

5. The keyboard according to claim 4, further comprising a display unit for displaying the current mode information according to the current mode signal.

6. An apparatus for defining keystroke values of a keyboard, comprising:
a first interface for connecting to a keyboard interface of a host computer;
a second interface for connecting to a keyboard, and receiving keystroke signals from the keyboard;
a storage unit; and
a micro control unit (MCU), comprising:
a defining module for defining keystroke mappings between keystrokes and keystroke values in a user-defined keystroke mode, and storing the keystroke mapping into the storage unit; and
an output control module for receiving the keystroke signals from the second interface, reading the corresponding mapped keystroke values from the keystroke mapping stored in the storage unit in the user-defined keystroke mode, and outputting the mapped keystroke values to the keyboard interface of the host computer through the first interface.

7. The apparatus according to claim 6, wherein the MCU further comprises a mode switch module for switching between a normal keystroke mode and the user-defined keystroke mode, in the normal keystroke mode, the output control module receives the keystroke signals from the second interface, and outputs default keystroke values indicated by the keycaps to the keyboard interface of the host computer through the first interface.

8. The apparatus according to claim 6, wherein the mapped keystroke value is selected from a group consisting of a keystroke value and a keystroke combination value.

9. The apparatus according to claim 6, wherein the mode switch module further generates a current mode signal, which indicates the current mode of the apparatus.

10. The apparatus according to claim 9, further comprising a display unit for displaying the current mode information according to the current mode signal.

11. A method for defining keystroke values of a keyboard, comprising the steps of:
defining keystroke mappings between keystrokes and keystroke values in a user-defined keystroke mode of the keyboard, and storing the keystroke mapping;
generating keystroke signals in response to the operational inputs on keycaps of the keyboard;
receiving keystroke signals;
reading corresponding mapped keystroke values from the keystroke mapping in response to the keystroke signals, in the user-defined keystroke mode; and
outputting the mapped keystroke values to a host computer.

12. The method according to claim 8, further comprising the step of:
outputting corresponding default keystroke values indicated by the keycaps in response to the keystroke signals, in a normal keystroke mode.

13. The method according to claim 8, further comprising the step of:
switching between the normal keystroke mode and the user-defined keystroke mode.

14. The method according to claim 8, further comprising the steps of:
generating a current mode signal indicating the current mode of the apparatus; and displaying the current mode information according to the current mode signal.
